(19) United States
(12) Patent Application Publication
(10) Pub. No.: US 2008/0015930 A1
(43) Pub. Date: Jan. 17, 2008

(54) Method of Managing Vehicle Parking Subscription Renewals

(75) Inventors: Thierry Mougin, Saint Vit (FR); David Perreard, Montferrand Le Chateau (FR)

Correspondence Address: YOUNG & THOMPSON, 745 SOUTH 23RD STREET, 2ND FLOOR, ARLINGTON, VA, 22202, US

(73) Assignee: PARKEON, Paris (FR)

(21) Appl. No.: 11/628,676

(22) PCT Filed: Jun. 8, 2005
(86) PCT No.: PCT/FR05/50426

§ 371 Date: Feb. 6, 2007

(30) Foreign Application Priority Data
Jun. 10, 2004 (FR) 0451156

(51) Int. Cl. G07B 15/00

(52) U.S. Cl. 705/13

(57) ABSTRACT

A method of managing renewals of subscriptions for the parking of vehicles in a geographical zone in which parking is regulated with pay-and-display machines that are installed therein. According to the invention, a person first obtains a subscription from a parking management operator for authorization to park one or more vehicles for a first determined period. The subscriber and the vehicle(s) are identified by identification elements which are recorded in a database of a central subscription management server (8) and parking is controlled by a control officer. In order to renew a subscription for a new period, the subscriber presents himself/herself at one (1) of the pay-and-display machines which communicates with the server (8), identifies himself/herself using the subscriber identification elements (2) and renews the subscription with the aid of the pay-and-display machine (1).

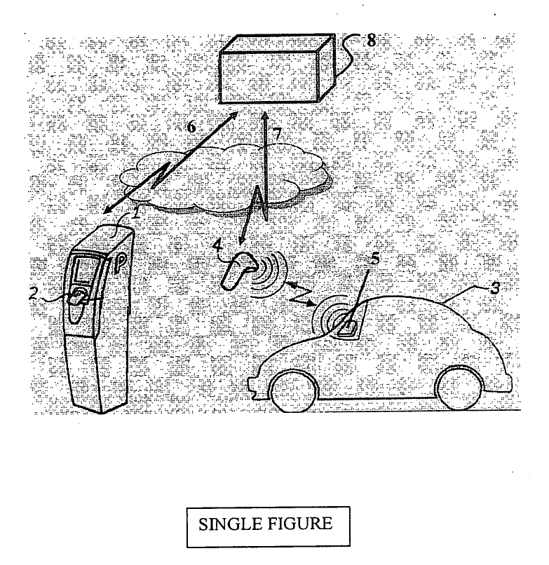

This invention relates to a method for managing renewals of subscriptions for the parking of vehicles in a geographical area where parking is charged for.

Regulated geographical parking areas for vehicles, mostly located in towns, are provided with equipment which enables motorists first of all to choose the period for which they wish to park (often restricted to a maximum of 2 hours) and then if necessary to pay the parking fees corresponding to the period selected. The equipment, generally called a paystation, then issues a ticket showing the limited permitted parking time and the price paid. The motorist places the ticket behind his vehicle's windscreen so that an attendant can check whether parking fees have been properly paid and that limiting parking times are not exceeded. Payment may be made in different ways depending upon the paystation equipment, for example using cash (but this is less and less frequent because of vandalism), credit cards or prepaid cards which can be obtained from particular shops.

More and more frequently those managing paying parking, the operators, offer subscription packages which are particularly useful to motorists who frequently park in chargeable areas. This applies for example to motorists who live within a chargeable parking area or who work in such an area. The purpose of these subscriptions, apart from obtaining preferential rates, is to ease the payment of subscription fees and thus to achieve a saving of time.

Three different ways of managing subscriptions and proceeding with payment for parking fees are generally distinguished.

According to a first method the parking operator provides a “paper” card and the subscriber regularly uses a paystation. The subscriber goes to a parking operator's booth or office, is recorded as a parking subscriber by presenting the necessary documents, and receives a paper card showing that he is recorded as a subscriber in a central database. In the case of a user who is a resident, the card is then specific to a particular area of the town relating to his place of residence. The card is merely evidence that the motorist is a subscriber to the service, but does not in any way constitute proof of payment for that service. The subscriber places (or sticks) the card behind his vehicle's windscreen and whenever he wishes to park his vehicle he goes to the paystation, presses a dedicated button to receive a preferential tariff, pays for the desired parking time and receives a parking ticket showing evidence of payment. He then places the ticket behind the windscreen of his vehicle alongside the card providing evidence of his subscription. The parking ticket includes an indication of the type of subscription or the subscription area. On his rounds the attendant merely checks that each subscriber's parking ticket corresponds to the rights shown on the “paper” card, in particular the nature of the subscription and the area of residence.

The main disadvantage of this type of arrangement is the fact that the subscriber has to go to a payment terminal every time he parks his vehicle in order to establish his right to park. This constraint is particularly important in the case of a resident user who has to go to the paystation every evening when he gets home from work although he is a subscriber. In addition to this the user retains his rights, or at least appears to, even if he moves or acts fraudulently, because this method of managing subscriptions does not offer any means of invalidating the card.

According to a second method of managing subscriptions, a card is issued to the subscriber, who no longer needs to use a paystation. In this case the subscription stage is similar to the previous method, that is to say the subscriber has to go to the parking operator's booth or office, provide the necessary documentation enabling him to obtain the tariff reserved for subscribers, and receives a card which he places behind his vehicle's windscreen. The payment which has to be made is a lump sum amount for the period in question (often one year) and the subscriber no longer has to go to a paystation and pay a parking fee whenever he parks. Payment may be made either for the entire subscription period, or in installments (for example monthly). In the latter case payment may possibly be made by automatically charging the subscriber's bank account. During his rounds the attendant merely checks the validity of the “paper” card for, for example, its expiry date or the parking area.

The main disadvantage of this type of arrangement arises from the fact that the subscriber has to go to a parking operator's booth or office whenever the subscription has to be renewed in order to receive a new card, or at the time when payments are made monthly (or at other intervals) in the case of all those users who do not have bank accounts or do not wish for their bank account to be debited automatically. Such users may of course prepay all the parking for the entire period, frequently a whole year, but the sum which has to be paid may be large. Also, this method of managing subscriber parking offers no way of invalidating the card, and the user at least apparently retains his rights even if he moves or acts fraudulently.

Finally, the third method of managing subscriptions is based on allocating the subscriber a card and systematic use of a paystation whenever he parks. The subscriber goes to the parking operator's booth or office, becomes recorded as a subscriber for parking by presenting the documents required, and receives a subscriber card providing evidence that he is recorded in a central database as a subscriber. In the case of a user who is a resident, the card is then specific to a particular area of the town relating to his place of residence. The card only provides evidence that the motorist is a subscriber to a service, but provides no evidence of payment for that service. In the event of a house move, attempts at fraud, loss or theft of the card, the card can be placed on a black list so that it is refused by paystations.

Whenever he wishes to park his vehicle the subscriber goes to a paystation, enters his subscriber card to benefit from a preferential tariff, pays for the parking time required and receives a parking ticket providing evidence of payment which he places behind his vehicle's windscreen. The parking ticket then provides an indication of the type of subscription or subscription area. During his rounds the attendant merely checks that the parking ticket is valid.

The main disadvantage of this method is the fact that the subscribing user has to go to a payment terminal whenever he parks his vehicle in order to provide evidence of his right to park.

The object of this invention is a method for managing regulated parking subscriptions which does not have the disadvantages of the prior art described above, while at the same time retaining its advantages. Thus, according to an advantageous embodiment of the invention, the advantages of the “subscriber” card are retained for subscribers and attendants, but without the inconvenience of the subscriber having to go to a paystation regularly in order to obtain a parking ticket or to go periodically to the parking operator's booth or office to pay parking fees, or have to undergo the disadvantages of automatic charges to his bank account.

More specifically, this invention provides for a method of managing subscription renewals for vehicle parking in a geographical area where parking is controlled through the use of paystations located in the said geographical area, the method comprising a preliminary step in which:
a user enters into a subscription contract with a parking management operator to permit parking of one or more vehicles for a first specified period within the said geographical area without it being necessary to use the paystation in order to obtain a parking ticket when parking in that geographical area,
the operator records identification data for the subscriber or the vehicles in the database of a central server,
   the said method being characterised in that:
during the preliminary step, means for identification of the subscription contract for renewal purposes are determined and recorded in the central server's database,
   and in that, for renewal of the subscription for a new period, the method further comprises the following steps:
the subscriber goes to one of the said paystations, and identifies himself using the said identification means,
the paystation communicates with the said server on the basis of the identification means to renew the subscription period.

Where the subscriber has to pay to renew his subscription, he pays using payment means available to the said paystation.

According to one embodiment, the said subscriber identification means comprise a card, preferably a contact or contact-free smart card provided by the operator at the time when a subscription contract is taken out, which is used to renew the subscription.

Advantageously the operator allocates a subscription number to that contract which is recorded in the said database and the said card holds in memory a serial number which is recorded in the said database and which is linked to the said subscription contract number.

One at least of the following data will be stored in memory on the said card: the vehicle registration number, the identification of the parking area, the type of parking (for example monthly or weekly), the expiry date for the said subscription contract and the expiry date for the latest renewal period.

According to another embodiment the said subscriber identification means are provided by the subscriber, for example in the form of a telephone number or a bank card number.

According to one embodiment the said attendant has a portable terminal which can communicate with the said server and thus access information present in the said database and check that the vehicle being checked corresponds to a currently valid subscription. The attendant may for example enter the registration number of the vehicle into the portable terminal and check that the said number corresponds to a currently valid subscription.

According to another embodiment the card is issued by the operator at the time when the subscription contract is taken out, the said card comprising a code recorded in the said database and being placed behind the vehicle's windscreen. The said code may be a serial number or a bar code and in this case the terminal is provided with means for reading bar codes.

According to one embodiment, when a parked vehicle is checked, the attendant uses the said portable terminal to communicate directly with the said server.

According to another embodiment, the data included in the said server database are placed in memory in the portable terminal, which periodically communicates with the server to refresh the data stored in memory in the portable terminal.

According to another embodiment the paystation provides evidence of subscription renewal comprising the vehicle's registration number and the expiry date for the renewal period, the said evidence being placed behind the windscreen, enabling the attendant to make a visual check.

Other advantages and characteristics of the present invention will become clear from the following detailed description which is given with reference to the drawing in the appended single FIGURE which illustrates the method according to the invention diagrammatically.

The vehicle owner must first of all take out a subscription which will permit him to park his vehicle within locations in the geographical area provided for the purpose. In order to do this the person or his representative goes to an operator's booth or office and if necessary presents all the documents providing evidence that they can benefit from a subscription (normally at a preferential rate). The subscription, and the subscription renewal, are generally charged for, but they may be free to some categories of persons, such as for example the handicapped.

When a subscription contract is taken out, the operator records the subscription contract number, information relating to the subscriber (name and address) and his vehicle or vehicles (registration number), as well as possibly the serial numbers of the card and renewal card described below, in a database in a central server 8.

The operator then issues that person with means which will enable the operator to identify that person, or to identify the subscription, when renewing the subscription using a paystation 1 located in the geographical area covered by the subscription. These means advantageously comprise a renewal card 2, preferably a smart card, incorporating a memory in which information through which the owner or the subscription can be identified has been recorded. This information preferably includes the card serial number (this number acting as a link with the subscription number), the registration number of the vehicle or vehicles, the renewal date of the contract and the date of the last subscription contract renewal period.

Alternatively no card is provided to the vehicle owner, but the latter provides the operator with means which will enable the latter to identify him when renewing the subscription and establishing a link with this subscription. For example the subscriber many identify himself using his mobile telephone.

The operator also records means which make it possible to identify the subscriber's vehicle 3, preferably the vehicle registration number, in the database of server 8. The operator may, but not necessarily, provide the subscriber with a card 5 indicating that a subscription has been taken out for that vehicle, which the motorist places behind the windscreen of vehicle 3. Provision of the card is in fact not compulsory because reading the vehicle's registration plate will make it possible to establish whether or not a subscription has been taken out for the vehicle in question through the database in server 8.

If the subscriber wishes to subscribe to a single subscription for several vehicles, he may do this provided of course that each of the vehicles is identified by providing the registration number of each vehicle for example. If cards are provided by the operator, one card is provided for each of the vehicles.

Server 8 communicates with both paystations 1 in the geographical area in question and a portable terminal 4 used by the attendant, through a cable link or by radio waves 6 and 7. According to this invention subscriptions are renewed by the subscriber directly using these paystations 1 without having to go to an operator's booth or office. Preferably, most if not all the paystations in the geographical area will communicate with server 8 and will thus make it possible to renew subscriptions.

In order to renew his subscription the subscriber goes to a paystation 1 within the geographical area which is capable of communicating by radio or wire with central server 8, identifies himself as a subscriber, preferably using a subscriber card 2, requests payment for the next subscription period, and pays it using one of the means of payment available to the paystation (for example cash, cash card, electronic account or bank card). The payment made is communicated by the paystation to server 8 in real time, and the latter places this payment in memory in its database. Paystation 1 issues the subscriber with evidence of payment. Where the subscriber belongs to a category of persons for whom parking is free, such as for example the handicapped, free parking is recorded on subscriber card 2 so that the subscriber can renew his subscription without having to pay.

In all the instances described, the server can update the database relating to renewal of the contract, and in particular the validity period of the subscription.

The attendant checks parked vehicles either visually or by using a portable terminal 4 of the Personal Digital Assistant (PDA) type or pocket computer.

A visual check may be made when the evidence provided by the paystation following payment for renewal of the subscription is placed behind the vehicle's windscreen. For this purpose the evidence includes the vehicle's registration number and the end of the renewal period for the subscription.

The check on valid parking is preferably carried out using portable terminal 4. In this case, when a parked vehicle does not have a parking ticket normally issued to non-subscribers by paystations, the attendant checks whether this vehicle benefits from a parking subscription or not. This check may be made using the vehicle's registration number or a code printed on the card which the attendant enters into portable terminal 4. This terminal communicates directly with server 8 by radio in order to determine by consulting the database whether the vehicle having registration number or code is in fact the subject of a valid subscription contract. The code on the card may be a bar code or a serial number.

Alternatively portable terminal 4 may include in its memory an at least partial copy of the database in server 8. The data stored in memory relate to the list of current subscriptions for each type of subscription (“resident” subscription for example), the validity period for the subscription contract and the last renewal date for the latter, as well as identification of the vehicle or vehicles corresponding to each subscription. The attendant can thus know directly whether or not the vehicle benefits from a valid subscription without having to communicate with the server directly.

The data in the memory of the portable terminal are regularly refreshed, for example daily whenever the attendant returns to his office to a workstation provided with a station receiving the terminal and connected to the subscription server via the operator's local network. This receiving station may also be used to recharge the batteries of portable terminals.

Card 5 may also be a contact-free smart card containing subscriber identification. In this case portable terminal 4 comprises means for remotely reading card 5, as illustrated in the single FIGURE. Advantageously, only the serial number of the card is included and printed on the card, so that if necessary the characteristics of the subscription can be changed without having to reprogram the card. This single number is unique and provides the link with the subscription. Another advantage results from the fact that no other information relating to the subscriber is displayed on the card and placed in the smart card's memory, as a result of which any fraudulent use of the information can be prevented.

In the embodiment described, the subscription contract number is associated with the serial number of card 5, a particular subscriber, a serial number of renewal card 2 and the vehicle reference (registration number). If the card, the renewal card or the vehicle are lost or stolen the unique numbers associated with these components are replaced in the subscription contract by the new serial numbers for the replacement units. For example the number of a lost or stolen card is replaced by the number of the replacement card. The serial number of the first card is then dissociated from the subscription contract and thereby invalidated. Conversely the contract number cannot be changed.

Renewal of subscriptions via paystations offers many advantages.

First of all for the user, it makes it possible for subscriptions to be renewed easily and quickly without having to go to the operator's booth or office. If for example the geographical area relates to a whole town and most of the paystations in that town can communicate with the operator's central server, a subscription can be easily and quickly renewed from any one of those paystations. Paystations may possibly permit a subscriber to consult information concerning him in the database of server 8 and also to discover the status of his subscription. He may also request print-out of a duplicate ticket of the payment receipt for his last renewal if the latter has been lost or if it is impossible to read for any reason whatsoever.

For the operator then there is no further need for booths or offices or personnel employed in renewing subscriptions, as a result of which the operating costs of the parking system can be reduced.

1-17. (canceled)

18. A method for managing the renewal of subscriptions for the parking of vehicles in a geographical area where parking is controlled through paystations installed within the said geographical area, the method comprising a preliminary step in which:
a user subscribes to a subscription contract with a parking management operator to permit the parking of one or more vehicles for a first specified period within the said geographical area without it being necessary to use a paystation in order to obtain a parking ticket when parking in that geographical area,
the operator records identification data for the subscriber and the vehicle or vehicles in a central server,
during the preliminary step, means for identifying the subscription contract for renewal purposes are determined and recorded in the central server's database,
for renewal of the subscription for a further period, the method also comprises the following steps:
the subscriber goes to one of the said paystations and identifies himself using the said identification means,
the paystation communicates with the said server using the identification means to renew the subscription period.

19. A method according to claim 18, wherein the said identification means comprise a card provided by the operator at the time when the subscription is taken out, the said card being used to renew the subscription.

20. A method according to claim 19, wherein the said card is a smart card.

21. A method according to claim 19, wherein when a subscription contract is taken out the said operator allocates the subscription number to the said contract which is recorded in the said database and in that the said card contains in memory a serial number which is recorded in the said database and which provides a link with the said number of the subscription contract.

22. A method according to claim 21, wherein at least one of the following data are placed in memory on the said card: the vehicle registration number, the identification of the parking area, the expiry date of the said subscription contract and the expiry date of the last renewal period.

23. A method according to claim 18, wherein the said identification means used for renewal of the subscription at the said paystation are provided by the subscriber himself.

24. A method according to claim 23, wherein the said subscriber identification means comprise the subscriber's telephone number or a bank card number.

25. A method according to claim 18, wherein the said attendant has a portable terminal which can communicate with the said server and thus gain access to information present in the said database and check that the vehicle checked corresponds to a currently valid subscription.

26. A method according to claim 25, wherein the attendant enters the registration number of the said vehicle into the said portable terminal and checks that the said number corresponds to a currently valid subscription.

27. A method according to claim 25, wherein a card is issued by the said operator when the subscription contract is taken out, the said card comprising a code which is recorded in the said database and being placed behind the vehicle's windscreen.

28. A method according to claim 27, wherein the said code is a bar code.

29. A method according to claim 27, wherein the said code is a serial number.

30. A method according to claim 28, wherein the said terminal is provided with means for reading bar codes.

31. A method according to claim 25, wherein when a parked vehicle is being checked the attendant uses the said portable terminal to communicate directly with the said server.

32. A method according to claim 25, wherein the data included in the said database in the server are placed in memory in the said portable terminal which communicates periodically with the said server in order to refresh the data stored in memory in the portable terminal.

33. A method according to claim 18, wherein at the time of renewal the said paystation (1) provides evidence of renewal of the subscription comprising the registration number of the vehicle (3) and the expiry date for the renewal period, the said evidence being placed behind the windscreen enabling the attendant to make a visual check.

34. A method according to claim 18, wherein the subscriber pays the price for renewing the subscription through payment means available to the said paystation.
